(19) United States
(12) Patent Application Publication
(10) Pub. No.: US 2026/0140657 A1
(43) Pub. Date: May 21, 2026

(54) EFFICIENT PROCESSING OF STORAGE REQUESTS AND COMPLETION NOTIFICATIONS INCLUDING AGGREGATION OF STORAGE REQUESTS AND COMPLETION NOTIFICATIONS

(71) Applicant: NVIDIA Corporation, Santa Clara, CA (US)

(72) Inventors: Christopher J. Newburn, South Beloit, IL (US); Isaac Gelado Fernandez, Pacifica, CA (US); Vikram Sharma Mailthody, Urbana, IL (US); Kiran Kumar Modukuri, San Ramon, CA (US); Wen-Mei W. Hwu, Champaign, IL (US); Zaid Qureshi, Wappingers Falls, NY (US)

(21) Appl. No.: 19/393,445

(22) Filed: Nov. 18, 2025

Related U.S. Application Data
(60) Provisional application No. 63/721,947, filed on Nov. 18, 2024.
(60) Provisional application No. 63/879,437, filed on Sep. 10, 2025.

(51) Int. Cl. G06F 3/06

(52) U.S. Cl. CPC G06F 3/0655; G06F 3/0604; G06F 3/0679

(57) ABSTRACT

The disclosure provides an apparatus, system, and method that augments the typical processing by a storage controller for storage access requests. An augmented data controller is disclosed that provides completion guidance to improve the processing of storage access requests, such as fine-grained data requests. The completion guidance can be generated based on semantic information provided by requesting agents and may be sent with storage access requests that are for a data read or write. The completion guidance allows software-defined completion notifications that are beneficial for accessing data, such as for multiple fine-grained (e.g. 4 KB or less), random sparse accesses that are emerging from processors, such as from GPU threads. The completion guidance is a result of the requesting agents providing additional contextual information for storage access requests to improve the intelligence of storage controllers and improve the efficiency of accessing data storage for obtaining or writing data.

### CROSS REFERENCE TO RELATED APPLICATION

This application claims the benefit of U.S. Provisional Application Ser. No. 63/721,947, filed by Christopher J. Newburn, et al., on Nov. 18, 2024, entitled “EFFICIENT NOTIFICATION OF STORAGE REQUEST COMPLETION”, and U.S. Provisional Application Ser. No. 63/879,437, filed by Christopher J. Newburn, et al., on Sep. 10, 2025, entitled “EFFICIENT PROCESSING OF STORAGE REQUESTS AND COMPLETION NOTIFICATIONS INCLUDING AGGREGATION OF STORAGE REQUEST AND COMPLETION NOTIFICATIONS”, which are both commonly assigned with this application and incorporated herein by reference in their entirety. This application is also related to U.S. Patent Applications having Docket Nos. 24-MA-1416US03, 24-MA-1416US04, and 24-MA-1416US06, filed by Christopher J. Newburn, et al., on the same day as the present application.

### TECHNICAL FIELD

This application is directed, in general, to data storage, and more specifically, to improved processing of storage requests directed to data storage, including the use of completion notifications.

### BACKGROUND

A new class of applications executing on processors, such as a GPU or a CPU, are making fine-grained accesses, such as from each GPU thread, creating the need for new interfaces, a new infrastructure, and a new generation of storage devices and systems. For example, the amount of data requested is typically greater than local memory and therefore is often stored on external memory devices connected to the processors. The input/output operations per second (IOPs) rates demanded by these new applications, however, cannot be satisfied by today's solid state drives (SSDs) and/or non-volatile memory express solid state drive (NVMes) and their associated operating system (OS) software stack. Improvements to the processing of storage access requests and responses can be beneficial to maintaining maximal effective IOPs rates.

### SUMMARY

In one aspect, the disclosure provides an augmented data controller configured to perform one or more operations associated with processing storage access requests from one or more requesting agents for one or more data sources. In one example, the operations include generating completion guidance associated with the one or more storage access requests, wherein the completion guidance includes aggregation instructions for aggregating the one or more storage access requests or for aggregating completion notifications of the one or more storage access requests.

In another aspect, the disclosure provides a storage processing interface. In one example, the storage processing interface includes: (1) a communication bus and (2) an augmented data controller connected to the communication bus and configured to perform one or more operations associated with processing storage access requests from one or more requesting agents for one or more data sources, the operations including providing completion guidance associated with the one or more storage access requests, wherein the completion guidance includes aggregation instructions for aggregating the one or more storage access requests or for aggregating completion notifications of the one or more storage access requests.

In yet another aspect, the disclosure provides a data storage system. In one example, the data storage system includes: (1) data storage configured to store data and (2) a storage processing interface having an augmented data controller configured to perform operations that include providing completion guidance associated with one or more storage access requests, wherein the completion guidance includes aggregation instructions for aggregating the one or more storage access requests or for aggregating completion notifications of the one or more storage access requests.

### BRIEF DESCRIPTION

Reference is now made to the following descriptions taken in conjunction with the accompanying drawings, in which:

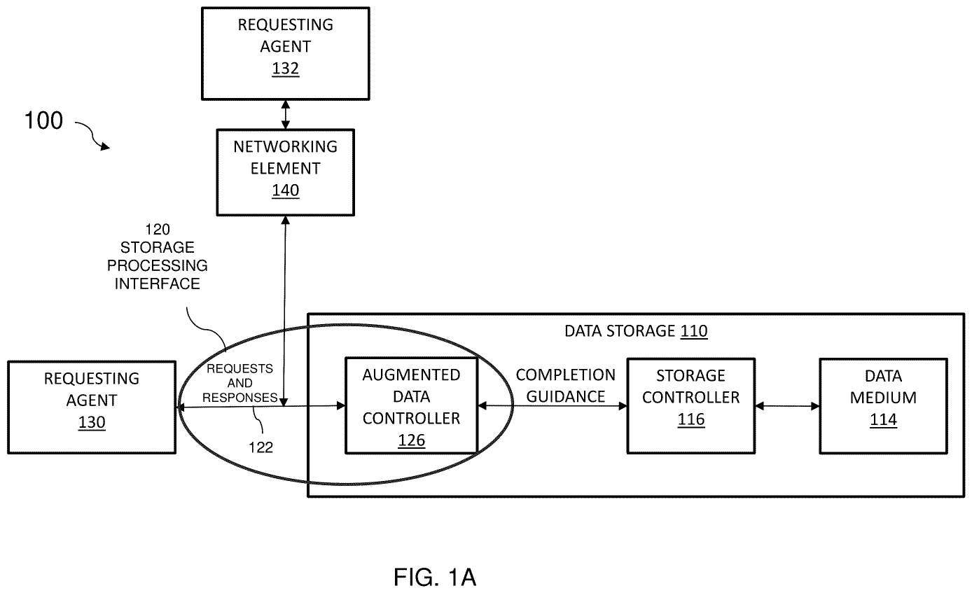

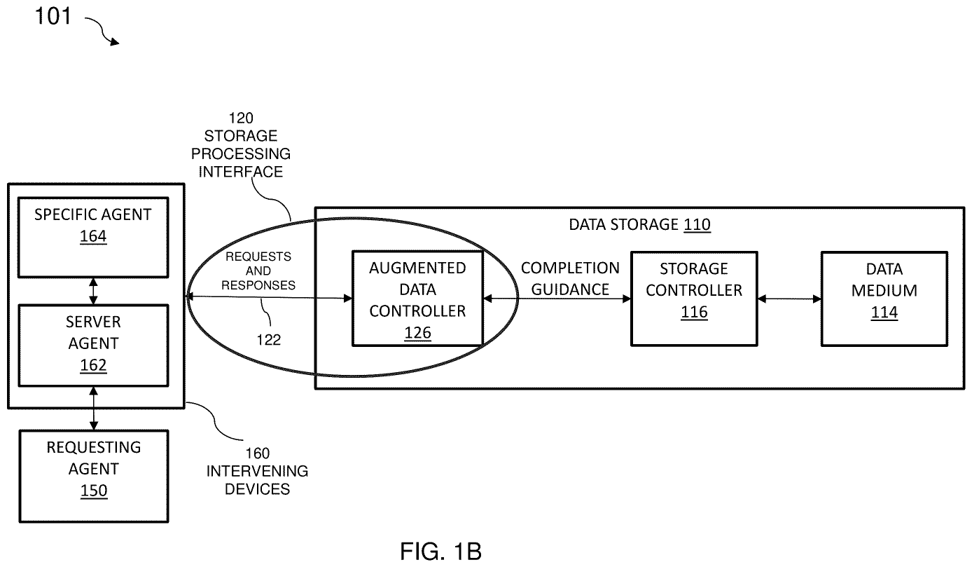

FIG. 1A illustrates a block diagram of an example of a data storage system having a storage processing interface constructed according to the principles of the disclosure;

FIG. 1B illustrates a block diagram of an example of a data storage system constructed according to the principles of the disclosure that has different types of intervening devices between a requesting agent and a storage processing interface;

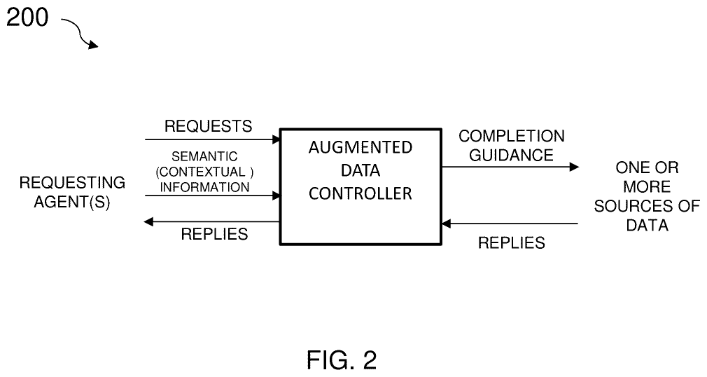

FIG. 2 illustrates a block diagram of an example of an augmented data controller constructed according to the principles of the disclosure;

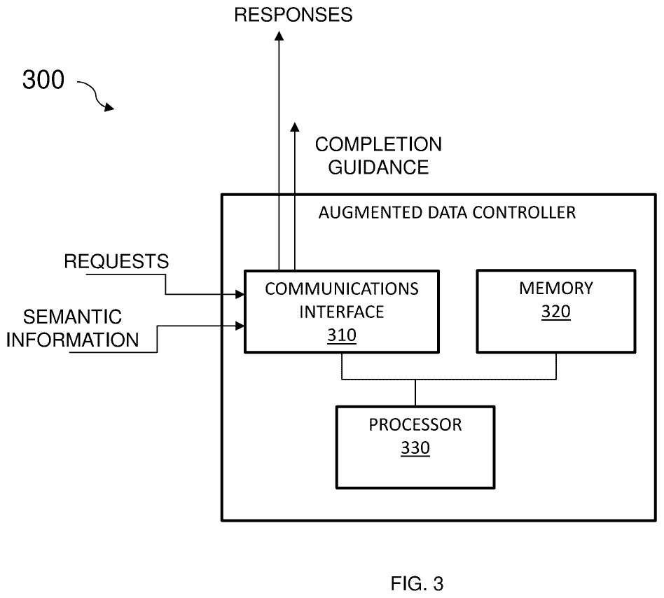

FIG. 3 illustrates a block diagram of another example of an augmented data controller constructed according to the principles of the disclosure; and

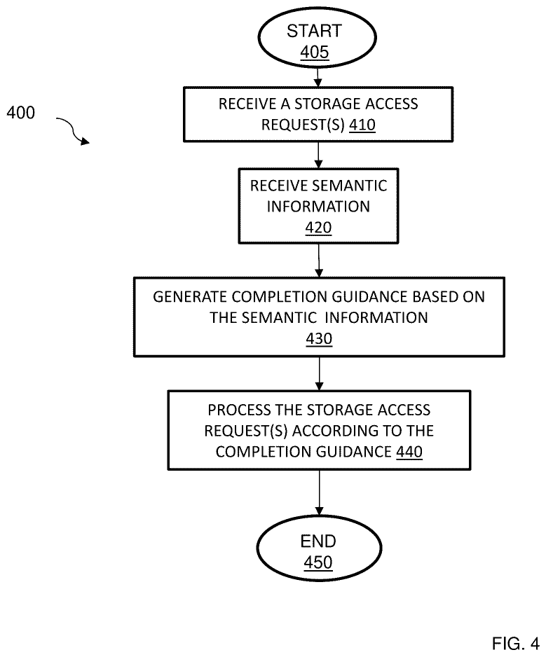

FIG. 4 illustrates a flow diagram of an example method of processing storage access requests for data storage carried out according to the principles of the disclosure.

### DETAILED DESCRIPTION

Storage controllers for various data storage devices typically receive storage access requests, such as data requests, from requesting agents, such as processors, and interact with a data medium of the data storage device to fulfill the requests and provide a response to the requesting agents. Improvements in completion notifications (e.g. completion flags) of requests is a part of the request/response processing that can result in improved IOP rates. Consider for example a GPU computing system. In a GPU computing system, traditional request completion notifications, such as the NVMe queue pairs, cause inefficient completion handling due to the massive number of threads with computing resources and scheduling constraints. A new class of software-defined notification mechanisms would be beneficial for processing storage access requests. For example, software-defined notification mechanisms that allow the threads in the same scheduling unit, e.g. warps, to handle the completion notifications for their read and/or write requests collaboratively with less divergence and redundant efforts would be advantageous.

Accordingly, the disclosure provides an apparatus, system, and method for executing completion notifications according to completion guidance. The completion guidance can be generated based on semantic information provided by requesting agents and may be sent with storage access requests that are for a data read or write. A request for data, or data request, is an example of a storage access request and will be used herein in some examples as a storage access request. For example, the completion guidance allows software-defined completion notifications that are beneficial for accessing data, such as for multiple fine-grained (e.g. 4 KB or less), random sparse accesses that are emerging from processors, such as from GPU threads. The completion guidance is a result of the requesting agents providing additional contextual information for storage access requests to improve the intelligence of storage controllers and improve the efficiency of accessing data storage for obtaining or writing data.

The amount of data to access can be, for example, a whole page of data, one or more codewords, or even a subset of a codeword. As used herein, a codeword is the smallest unit of data for which check bits can be employed to perform error correction and a subset of a single codeword, or sub-codeword, is a unit of data that is smaller than a codeword.

An augmented data controller is disclosed that provides the completion guidance to a storage controller or other devices of a data storage system to improve, for example, processing data requests, such as fine-grained data accesses. The logic of the augmented data controller can be located within a storage controller itself or in another device such as a requesting agent, an intervening device, or within a data storage device besides within the storage controller. The logic can also be distributed over multiple devices, such as those just mentioned. As such, the various functions and features disclosed herein can be applied to different types of computing elements (e.g., CPU, DPU, FPGA, etc.) or storage elements (e.g., NVMe, SSD) that can send back data. The logic of the augmented data controller can be implemented as software, hardware, or a combination thereof. For example, the logic or at least a portion of the logic can be implemented as a hardware finite state machine or as software in a GPU, CPU, of DPU.

FIG. 1A illustrates a block diagram of an example of a data storage system 100 having a storage processing interface constructed according to the principles of the disclosure. Data storage system 100 includes data storage 110, a storage processing interface 120, one or more requesting agents represented by requesting agent 130 and requesting agent 132, and one or more intervening agents (i.e., intervening devices) represented by networking element 140. The data storage 110 includes a data medium 114 and a storage controller 116.

Data storage 110 is configured to retain digital data in a computer-readable medium, which is represented by data medium 114 in FIG. 1. The data medium 114 can be non-volatile memory, such as flash memory, magnetic disks, such as hard disc drives (HDDs), or another computer readable medium. The data medium 114 can also be a solid-state storage device, such as a SSD including an NVMe, or a DNA data storage device.

Storage controller 116 is configured to manage communications with the data medium 114, such as communications with the requesting agent 130, using one or more channels or busses. The storage controller 116 can also be configured to provide additional functions for the data medium 114, such as encryption, compression, and error correction. The storage controller 116 can be, for example, an application-specific integrated circuit (ASIC) having an embedded processor.

Storage processing interface 120 is configured to communicatively connect and process communications with the data storage 110 to and from the requesting agent 130 and the networking element 140. The storage processing interface 120 includes a communication bus 122 and an augmented data controller 126. The communication bus 122 is configured to physically connect the data storage 110, the requesting agent 130, and the networking element 140 for communication therebetween. The communication bus 122 can be a high-speed interconnect. For example, the communication bus 122 can be a peripheral component interconnect (PCI) bus, a PCI express (PCIe) bus, a compute express link (CXL), an NVLink from NVIDIA Corporation of Santa Clara, California, or a network. Examples of communications via the communication bus 122 include data requests from the requesting agent 130 to the data storage 110 and data responses from the data storage 110 to the requesting agent 130.

The requesting agents 130 and 132 can be a processor, such as a GPU or a CPU. One or more of the multiple requesting agents, such as requesting agent 132, can be coupled to the communication bus 122 via one or more intervening devices, such as networking element 140. FIG. 1B provides an example of other intervening devices.

The networking element 140 can be a networking device, such as a network interface card (NIC) or a microprocessor designed for networking. For example, the networking element 140 can be a data processing unit (DPU). The networking element 140 can be configured to map a region of the data medium 114 for access by the networking element 140. For example, the networking element 140 can use User Memory Registration (UMR). The UMR can use one or more of a repeat count, a fixed chunk size, and/or a fixed stride. The UMR can also parse and operate on a list of non-strided items.

The augmented data controller 126 is configured to provide completion guidance according to received semantic information. The augmented data controller 126 can provide the completion guidance, or at least a portion thereof, to storage controller 116. As shown in FIG. 1A, the augmented data controller 126 can be located within data storage 110. As noted above, the logic of the augmented data controller 126 can also be integrated in another device such as the requesting agent 130, the networking element 140 or another intervening device, or within another data storage device besides the data storage 110. The augmented data controller 126 can be integrated in the storage controller 116. The logic can also be distributed over multiple devices, such as those just mentioned. The logic of the augmented data controller 126 corresponds to one or more algorithms that are directed to providing completion guidance according to the received semantic information.

The completion guidance includes one or more instructions for processing storage access requests for the data storage 110, such as processing completion notifications of storage access requests for the data storage 110. The completion guidance enables aggregation of multiple completion notifications of requests and acting on the multiple completion notifications after the aggregation. Acting on the multiple completion notifications can be based on one or more error notifications associated with one or more of the multiple completion notifications. The completion guidance can also enable aggregation of the storage access requests and responses to the requests.

The completion guidance can define various features for processing completion notifications. The various features include, for example, a format for the completion notifications, a completion queue location to update according to the completion notifications, a value to update a completion queue according to the completion notifications. The format can be a number of bits and semantics of the encoding, such as a single value or a bit vector.

Using the completion guidance can result in adding one or more additional operations for executing the completion notifications compared to not using the completion guidance. The one or more additional operations can be atomically incrementing an index into an array of entries that indicates where to write a subsequent one of the completion notifications. The one or more additional operations can also include atomically adding to an index a size of a structure of at least one of the completion notifications that is written. The one or more additional operations can include decrementing a down counter of a number of the requests that are outstanding. An initial value of the down counter can be assigned, such as N, and the one or more additional operations can include enabling the completion notification after every N completions.

The one or more additional operations can be related to sending the completion notifications. For example, sending the completion notifications based on a number of the requests that have completed and sending the completion notifications before the number of completed requests when an error condition occurs.

Sending of the completion notifications can be performed in different ways. For example, an interrupt can be used. A direct memory access (DMA), such as a remote DMA (RDMA), can also be sent to a given location. Polling to an updated completion queue entry (CQE) is another example of communicating a completion notification. Polling to a semaphore is another option, which can also be used to check for an error condition. The completion guidance can define the process, such as indicating the given location, for signaling completion notifications.

The completion guidance can also define the operating of one or more completion queues. The operating of one or more completion queues can be defined according to one or more of the availability of computing resources for processing the completion notifications, an outstanding number of the requests, or an outstanding number of the requests that have been completed. The operating of the one or more completion queues can be defined by using a common completion queue for processing a subsequent one of the completion notifications when the available computing resources are less than a number of the requests that are outstanding and have a possibility of completing out of order. The number of computing resources relative to the outstanding requests can be assessed using a tunable threshold ratio that can be set by one or more of the requesting agents, such as the requesting agent 130 and/or the networking element 140, via software. A neural network can be used to learn the tunable threshold ratio. Other machine learning approaches can also be used to learn the tunable threshold ratio. The neural network can be located in, for example, the storage controller 116, the requesting agent 130, network element 140, or in the data storage 110 external to the storage controller 116. The neural network can also be located in the augmented data controller 126.

The operating of the one or more completion queues can also be defined by posting the completion notifications according to context of each of the one or more completion queues when a number of the computing resources is within a defined range of a number of the data requests. The defined range can be set by software operating on a requesting agent, such as requesting agent 130 of networking element 140. As with the tunable threshold ratio, a neural network or other machine learning approaches can be used to learn the defined range.

The operating of the one or more completion queues can also be defined by posting the completion notifications according to context of each of the one or more requesting agents task state when a number of the computing resources is within a defined range of a number of the completion notifications but the number of the completion notifications is smaller compared to a number of the requests that are outstanding. Software can be used to set the defined range. A neural network or another machine learning approach can learn the defined range.

The augmented data controller 126 is also configured to provide the data responses from the data storage 110 according to the completion guidance. For example, the completion guidance can have instructions for including a flag with responses to the data requests wherein the flag can indicate completion of the requests. The responses to the requests can be fine-grained, one-sided, low latency data transfers. The responses to the requests can also be atomically-updated data.

A single response can cover or satisfy multiple data requests and one or more or even each of the multiple data requests can be to a disjoint memory region of, for example, data medium 114. The single response can be in a scatter or gather fashion for each of the disjoint memory regions. Responses to the data requests can also be to one contiguous region of the data medium 114 instead of disjointed memory regions. The responses to the requests could be a set of regions of the data medium 114 with a fixed stride. The responses to the requests can also be to a list of arbitrarily-spaced regions. The one or more requesting agents can distribute parts of a common response to disjoint memory regions. The one or more requesting agents that does the distribution from the response could be implemented as software in a computing agent (CPU or GPU or DPU), such as requesting agents 130 or 132, or a hardware finite state machine in storage controller 116 or networking element 140.

The source of a response can be the data storage 110. The source of a response can also vary and there can be more than one source for a response. For example, one or more intervening devices can be a source. A combination of sources can also be used for a response and aggregation of data for a response can occur in various degrees by the different sources. Different priorities for processing can also be assigned to aggregated sets of requests.

An aggregated set of requests may involve resources at one or more of the sources that need to be managed. For example, memory-mapped input/output (MMIO) reads or writes with side effects may be used to manage state from one or more sources. The augmented data controller 126 can be used to manage the resources. As such, management of the resources can be located within storage controller 116, requesting agents 130 or 132, or an intervening device such as networking element 140. If the management function is within the data storage 110, a set of commands for allocating, freeing, checking the availability, and cleanup of the different sources can be present. An example of the different source is one or more of intervening devices 160 of FIG. 1B.

FIG. 1B illustrates a block diagram of another example of a data storage system 101 having storage processing interface 120. In addition to storage processing interface 120, data storage system 101 also includes data storage 110 that has data medium 114 and storage controller 116. Data storage system 101 further includes requesting agent 150 and the intervening devices 160. As with data storage system 100, data storage system 101 can also have more than one requesting agent. Like requesting agents 130 and 132, requesting agent 150 can be a processor, such as a GPU or a CPU. Requesting agent 150 is connected to the storage processing interface 120 via one or more intervening agents, which are represented by intervening devices 160. Though two intervening devices 160 are shown, only one or more than two intervening devices may be present.

Intervening devices 160 are located between requesting agent 150 and the storage processing interface 120. Server agent 162 and specific agent 164 are examples of intervening devices. Specific agent 164 can be configured to manage data storage 110, or more specifically, data medium 114. For example, data medium 114 can be a SSD and specific agent 164 can be a SSD-specific agent that is configured to manage the SSD. Server agent 162 can be configured to manage multiple data mediums, such as multiple SSDs. Server agent 162 and/or specific agent 164 can be a source of a response delivered to the requesting agent 150 and either one (or both) can also include portion of the logic of augmented data controller 126. Accordingly, one or more of server agent 162 or specific agent 164 can aggregate a response for the requesting agent 150. Aggregation of responses can occur to varying degrees by the server agent 162, the specific agent 164, or the augmented data controller 126.

FIG. 2 illustrates a block diagram of an example of an augmented data controller 200 constructed according to the principles of the disclosure. The augmented data controller 200 is configured to perform one or more operations associated with obtaining data from data storage for a requesting agent. The augmented data controller 200 provides an example of the augmented data controller 126 of FIGS. 1A and 1B.

The augmented data controller 200 is configured to receive one or more storage access requests from one or more requesting agents that are directed to a storage controller of a data storage. Additionally, the augmented data controller 200 is configured to receive one or more data responses from the storage controller that are directed to the one or more requesting agents for the one or more data requests and is configured to provide or send the one or more data responses to the one or more requesting agents according the completion guidance. In addition to storage access requests, the augmented data controller 200 is also configured to receive semantic information from the one or more requesting agents. The augmented data controller 200 can include a communications interface for receiving the requests and semantic information and for sending completion notifications and data responses.

The augmented data controller 200 also includes one or more processors that are configured to perform one or more operations. The operations include, for example, providing completion guidance to a storage controller associated with the data storage, wherein the completion guidance enables aggregation of storage access requests, aggregation of multiple completion notifications, and acting on the multiple storage access requests and/or completion notifications after the aggregation. As such, the augmented data controller 200 is configured to generate completion guidance for completion notifications of one or more storage access requests and generate aggregation instructions for the storage access requests, completion notifications, or both.

In addition to aggregating completion notifications or storage access requests, the operations of the augmented data controller 200 can also include aggregation of responses for a single requesting agent or for multiple requesting agents. Since the logic of the augmented data controller 200 can be distributed, multiple devices can communicate what and/or how to aggregate via completion guidance. Examples of devices that can be configured to generate and communicate aggregation instructions via completion guidance include requesting agents 130, 132, and 150, and intervening device 140, 162, and 164.

Aggregation instructions for completion notifications and/or for data responses (wherein both are generally referred to as replies) can vary for different storage access requests. For example, a tag can be included with each storage access request of an aggregated set to indicate the corresponding replies to aggregate. A number or count of replies in the aggregated set can also be included with the aggregation instructions and a counter, such as included with augmented data controller 200, can be used to count the storage access requests having a particular tag and/or a count of the remaining or next storage access requests having the particular tag. The augmented data controller 200 can be configured to perform the operations of the counter. In some examples, a number of untagged storage access requests or the next untagged storage access requests can be counted. The number of storage access requests with a particular tag can be, for example, inserted as a special command or integrated into one of the storage access requests itself. Or the number could be written to some other location that is consulted. There may be one location and value per storage access request, or it may be shared in common across one or more storage access requests, as configured.

The aggregation instructions can indicate to aggregate based on consecutive data locations or to aggregate based on consecutive completion flag locations carried in a storage access request. A data response, for example, may be larger than normal by a factor of the number of consecutive request locations being responded to, wherein aggregation would be beneficial. With this approach, RDMA or messages that are explicitly handled by a receiving agent at a requesting agent can be used. Also, a network element, such as a NIC, may have special functionality that enables it to scatter or gather response data into or from the requesting agent. As such, a requirement for a single, contiguous write may be relaxed, although there may still be some limits imposed, e.g. how far apart the different elements in the scatter gather list can be. The contiguity of response data and flag data for requests may be treated independently, e.g. those that happen to have consecutive flag locations need not be linearly consecutive in the requesting agent's linear address space.

A special command can also be used to indicate the beginning of a sequence of storage access requests to aggregate. The location/address of this special command can be remembered. When the next such special command is enqueued to the same IO queue, the earlier special command can be updated with a pointer to the later special command. All commands between the two can be considered as an aggregation. This makes it efficient to find the special command at the end of the sequence and allows the number of commands being aggregated to be unknown at the time that the earlier special command is written, and only known when the later special command is written. Advantageously, processing of one or more storage access requests that are between distinct pairs of special commands can be handled concurrently.

There may be multiple aggregated sets of storage access requests, with each one or the aggregated sets calling for aggregated notification after the completion of all members of that aggregated set. There may be several ways in which the multiple aggregated sets overlap. For example: 1) It is possible that storage access requests in each aggregated set are contiguous within the set but disjointed across the aggregated sets, but the handling of such different sets could be handled concurrently. 2) It is possible that the storage access requests from each set are interleaved, but are marked uniquely, e.g. with a different tag, or a different notification location, or a different semaphore.

A marker can be used to indicate a completion notification should be sent when the requests before the marker are completed. The marker could be based on sequence, a tag (color), or some field in the request or requests. Markers can also be used to write a value to a location to indicate what requests have been completed. Each consecutive marker can write the next consecutive value, thereby indicating the particular requests that have been completed. For example, marker one can write 1 to indicate set 1 is complete, marker two can write 2 to indicate set 2 is complete, marker three write 3 to indicate set 3 is complete, etc. The completion notifications from the markers can be used to manage processing pipelines. For example, a Window Display Driver Model (WDDM) or other virtual memory management system can interpret the signal information from the markers to enforce predictable pipelines. Requests between the markers could be processed in parallel, but depending on implementation, e.g., sequential queues, may get processed serially up to the next marker.

As such, processing requests of an aggregated set can happen concurrently or serially. The detection of the requests of the set and size of the set need not happen serially but could be known ahead of time. Sequential processing of requests can be done to find “the next” set. For example, the requests between one marker and “the next” marker can be processed or the next N requests following a marker can be processed. N could be a lower bound that can be subsequently updated if more requests are added later to the aggregated set.

Members of an aggregated set can also be processed concurrently, such as requests with a given tag or requests with a common pointer to resources, wherein a semaphore can be used.

Resources that aid in the efficient response could be allocated prior to issuing an aggregated set and deallocated after the completion of the aggregated set, such as via aggregation preparation.

Preparing to facilitate aggregation may be needed and can be performed by augmented data controller 200. As such, considering a distributed augmented data controller 200, preparing for aggregation can be performed in one or more of a requesting agent, an intervening device, of data storage. Instructions for the preparing may be communicated using the completion guidance.

One example of preparing is sorting. Individual storage access requests may be simply sorted but left distinct, or they may be combined into an aggregated set of storage access requests. For example, a requesting agent doing the sorting can nominate candidate requests for aggregation.

Another example of preparing is formatting. An aggregated storage access request may share a single CQE, or several separate ones. A new or special format may be used with the CQE if the completion flags are contiguous but the data entries are not. Various formats for the CQE can be used. For example, there can be one very general CQE format and/or a variety of CQE formats that are unique for each special case.

Additionally, each storage access request in an aggregated set may refer to the same CQE to be updated, enabling the use of a single CQE per set of aggregated responses versus one CQE per request. A counting semaphore can be used in conjunction with the single CQE.

Using the completion guidance can result in one or more additional operations for fulfilling storage access requests, such as reporting or notification of errors (e.g. error notifications). A CQE can be used for error notifications associated with responses to requests. Various reporting scenarios can be employed and in some instances can be decoupled from completion notifications. Examples of error notifications are provided below.

For instance a CQE can always be updated and used to indicate one or more errors that occur. A CQE can be used to indicate each of the one or more errors. In one example, a CQE can be relied upon to indicate completion of a storage access request. In another example, a CQE can only be relied upon to indicate an error and therefore provide an error notification.

In another scenario, the CQE is not always updated. For example, the CQE is only used if there is an error. Alternatively, the CQE may never be used for error notification.

Accordingly, the completion guidance can advantageously use a CQE for various functions including error notifications or for only bookkeeping. For example, a CQE can be used to track completion of requests, indicate an error status, and be pollable, or findable, after a completion notification signal. A CQE can be used one per request or one per a set of requests. As noted previously, a CQE may not be used to indicate an error. Instead, another mechanism like a semaphore can be used.

A semaphore can be used that counts down to 0 then sends a signal. A down counter can be used and decrement a number of the requests that are outstanding. The augmented data controller 200 can include the down counter or simply a counter. A counter can be dynamically chosen per a marker or a tag. An initial value of the down counter can be assigned. A requesting agent can allocate an available counter and can specify a counter to use in a storage request. A requesting agent can also allocate a resource for a counting semaphore. The resource can be one of the components of the data storage system 100 or data storage system 101, such as one of the intervening devices 160, networking element 140, augmented data controller 126, etc.

The resource can receive an allocation request and find an available counting semaphore data structure entry. The semaphores could be, for example, in data storage 110 to make atomic updates easier. The number of entries could be limited in number and the semaphores could be implemented in firmware memory versus hardware. If a data structure is available, the resource can return index with success. If not available, either a block or a fail can be returned.

Once a deallocation request is received, the resource can be freed.

The resources can be managed. For example, a resource can be co-located with the data storage 110 and can be updated upon completions, which can be common to multiple requestors. A resource can also be located external to the data storage 110, such as within one of the requesting agents when, for example, the requesting agent has exclusive management access to at least a subset of counting resources and source of truth communicates correct state upon initialization.

A requesting agent can also initialize a counting semaphore with the size of a storage access request set, or when waiting for all requests for a set of tasks, initialize the set to be the summation of the requests. The augmented data controller 126 can be configured to decrement a counting semaphore when a request of set is successfully completed and set the counting semaphore to a negative value when a request had an error.

A counting semaphore can be used to provide atomic access. An index of the semaphore to be used can be carried in the one or more storage access requests that share it and can be used to indicate the initial value. Each of the one or more storage requests can include an index to a pre-allocated counting semaphore. For example, an index value of 1 can correspond to a table entry that indicates 5 remaining requests of a storage request set, wherein an index value of 2 can indicate 0 remaining requests and that the set is complete. A negative value for the counter can also be used that indicates an error that can then be polled.

A negative semaphore count can be used to define one error. The negative value for the semaphore can be set, for example, to −1 and used to indicate that there was some error in the whole aggregated set. A negative semaphore value can be used to indicate a supplemental structure to hold each of a set of errors. The negative value could simply indicate that an extra field of the counting semaphore entry is valid in pointing to a structure which holds the set of such errors. A table of semaphore entries can be used and managed. For example, the index of the first entry in the set to have an error, or a sample index from one or more storage access requests that had an error can be used. One or more status locations with error code can also be noted and then read if a semaphore indicated an error. A counting semaphore can be managed by deallocating, resetting, and marking it as available for use. A receiving entity at a requesting agent can be configured to perform the deallocating, resetting, and marking for a requesting agent. In a stateful, connection-oriented approach, a requesting agent may also send an indication to a responding resource to perform an action related to cleaning up a state of a semaphore.

The augmented data controller 200, or a storage agent such as a WDDM storage agent, can also be configured to perform an action upon triggering. The action can pre-configured based on the trigger. In one instance, a value can be written to a reachable data location to, for example, effect a hardware trigger, such as of a requesting agent or another GPU. In another instance, a counter of ordered counters can be incremented. For example, each semaphore entry of a semaphore table can tracks its sequence number K within a sequence of tasks and when a given semaphore triggers, it does a swap to another counter, such as a second counter K-1, K. The table can identify the type of counter corresponding to an index value, such as an up or down counter. Counters 1, 2, and 3 can be designated as down counters and each one tries to write their sequence value (e.g., 1, 3, 2) to the second counter identified as counter 4. Counter 4, which is an up counter, can be initialized to 0 and updated to 1 by counter 1 when counter 1 triggers and counter 4 value is 1−1=0. Counter 4 is updated to 2 by counter 3 when counter 3 triggers and counter 4 value is 2−1=1. Counter 4 is updated to 3 by counter 2 when counter 2 triggers and counter 4 value is 3−1=2. This scheme can be used to force sequentiality of completion reporting among tasks and can advantageously reduce or provide no interrupts, poll based on the second counter (counter 4), trigger for markers on the counters, and provide a low compute load on a requesting agent.

FIG. 3 illustrates a block diagram of another example of an augmented data controller constructed according to the principles of the disclosure. The augmented data controller 300 of FIG. 3 includes one or more communications interface, represented by communications interface 310, one or more memories, represented by memory 320, and one or more processors, represented by processor 330. The various components of the augmented data controller 300 can communicate via wireless or wired conventional connections. As noted above, a portion of the augmented data controller 300 can be located at one or more locations in one or more devices.

Communications interface 310 is configured to transmit and receive data. For example, communications interface 310 can receive storage access requests, semantic information, and commands from one or more requesting agents. The semantic information is a word or multiple words that provide semantic guidance for processing the storage access requests, including processing one or more completion notifications for the storage access requests and/or for processing one or more data responses to data requests. The semantic information can include the commands and/or additional contextual information for completion guidance. Communications from the requesting agents can be received via a communications bus, such as communication bus 122 of FIG. 1A. The communications interface 310 can also receive data responses from and provide completion guidance to a storage controller, such as storage controller 116 of FIG. 1A.

Memory 320 can be configured to store a series of operating instructions that direct the operation of processor 330 when initiated, including supporting code representing one or more algorithms for processing storage access requests, completion notifications, and data responses using completion guidance. Memory 320 is a non-transitory computer-readable medium. Multiple types of memory can be used for the data storage systems and memory 320 can be distributed.

Processor 330 can be one or more processors. Processor 330 can be a combination of processor types, such as a CPU, a GPU, a single instruction multiple data (SIMD) processor, or other processor types. Processor 330 can be a virtual process supported by a processing unit. Processor 330 can be dedicated circuitry within a processor. Processor 330 can be a code process running on a processor. Processor 330 can be configured to, for example, generate completion guidance.

Processor 330 can be an integrated circuit. In some aspects, processor 330, communications interface 310, memory 320, or various combinations thereof, can be an integrated circuit. Processor 330 includes the logic to communicate with communications interface 310 and memory 320, and perform the functions described herein, including generating completion guidance using semantic information from one or more requesting agents.

FIG. 4 illustrates a flow diagram of an example method 400 of processing storage access requests for data storage carried out according to the principles of the disclosure. One or more of the steps of method 400 can be carried out by an augmented data controller and/or storage processing interface, such as storage processing interface 120 and augmented data controllers 126, 200, and 300 as disclosed herein. Method 400 begins at step 405.

In step 410, one or more storage access requests are received. The one or more storage access requests can be data or write requests from a single requesting agent or from multiple requesting agents and directed to one or more storage controllers of one or more data storage, such as storage controller 116 of data storage 110. Examples of different requesting agents include requesting agents 130, 132, 150, intervening devices such as networking element 140, server agent 162, and specific agent 164, or a processor such as a GPU, CPU or DPU. An augmented data controller can receive the one or more storage access requests from the one or more requesting agents.

In step 420, semantic information is received. The semantic information provides contextual information associated with the one or more storage access requests. The semantic information can also be received by the augmented data controller from the one or more requesting agents. The semantic information can be from one, multiple, or all of the requesting agents contributing to the one or more storage access requests. The semantic information provides semantic guidance for processing the one or more storage access requests. The semantic information can provide the semantic guidance for processing one or more completion notifications for the storage access requests, such as read or write requests, and/or for processing one or more data responses to read requests for data. The one or more storage access requests and the semantic information can be received via a communication bus, such as communication bus 122 of storage processing interface 120.

Completion guidance for processing the one or more storage access requests is generated in step 430 based on the semantic information. Generating the completion guidance can include generating commands and instructions for the storage controller based on the semantic information. The generating can also include providing the completion guidance in the format or protocol used by the storage controller. As such, the generating can include translating the semantic information from one format to another format. In some instances, the semantic information may be in the proper format for the storage controller when received. The augmented data controller can generate the completion guidance according to the semantic information.

For example, the semantic information can include instructions for processing completion notifications, such as indicating a particular format for the completion notifications. Based thereon, completion guidance can be generated to define the format for the completion notifications, such as indicating a number of bits and semantics for the encoding. Based on the semantic information, the completion guidance can also provide instructions for sending a completion notification using a DMA, a RDMA, polling to an updated CQE, or polling to a semaphore.

The semantic information can also provide instructions and/or preferences for the operation of completion queues and the completion guidance can define the operating of one or more completion queues accordingly, such as based on one or more of availability of computing resources for processing the completion notifications, an outstanding number of the requests, or an outstanding number of the requests that have been completed.

The semantic information can also requests flags with responses to storage access requests, such as data requests. As such, the completion guidance can be generated with instructions for including a flag with responses to the data requests wherein the flag indicates completion of a data request.

The semantic information can provide directions for aggregating storage access requests, completion notifications, or both and completion guidance can be generated having one or more instructions for aggregating the one or more storage access requests, the one or more completion notifications, or both. The aggregating instructions can indicate using a tag with each request of an aggregated set of the storage access requests to indicate aggregation of corresponding responses and/or completion notifications to aggregate. The aggregating instructions can indicate to aggregate based on consecutive data locations or to aggregate based on completion flag locations carried in a request and can include assigning different priorities to different aggregated sets.

The semantic information can also address error notifications wherein completion guidance can be generated to instruct using a CQE for error notifications or a semaphore for error notifications. The semantic information and corresponding completion guidance can provide a constraint by preventing a task of a requesting agent from completing or even start when the task is dependent on a storage access request set that has one or more errors.

In step 440 the one or more storage access requests are processed according to the completion guidance. For example, data can be obtained from a data medium, such as data medium 114, or data can be written to the data medium. Completion notifications can be sent and, additionally, error notifications can be sent when errors are present during the processing. As noted above, processing of the one or more storage access requests can also include aggregating the completion notifications, aggregating the storage access requests, and/or aggregating response to the one or more storage access requests.

After the processing, method 400 continues to step 450 and ends. Method 400 can be repeated multiple times during the operation of the one or more requesting agents.

A portion of the above-described apparatus, systems or methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more of other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs may be included on a graphics card that includes one or more memory devices and is configured to interface with a motherboard of a computer. The GPUs may be integrated GPUs (iGPUs) that are co-located with a CPU on one chip. Configured or configured to means, for example, designed, constructed, or programmed, with the necessary logic and/or features for performing a task or tasks.

Portions of disclosed examples or embodiments may relate to computer storage products with a non-transitory computer-readable medium that have program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include both machine code, such as produced by a compiler, and files containing higher level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions, and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

Various aspects of the disclosure can be claimed including the apparatuses, systems, and methods disclosed in the Summary. Each of those aspects can have one or more of the following additional elements in combination: Element 1: wherein the operations further include preparing for the aggregating of the one or more storage access requests or the one or more completion notifications. Element 2: wherein the preparing includes sorting. Element 3: wherein the sorting includes sorting individual requests of the one or more storage access requests and leaving the individual requests distinct. Element 4: wherein the sorting includes sorting individual requests of the one or more storage access requests and placing them in an aggregated set of requests. Element 5: wherein the preparing includes formatting a completion queue entry (CQE). Element 6: wherein the formatting includes defining a format when completion flags are contiguous but data entries are not. Element 7: wherein contiguity of response data for the one or more storage access request and flag data for the one or more storage access requests are treated independently. Element 8: wherein the formatting includes defining multiple formats that are unique for different situations. Element 9: wherein the formatting includes defining a general format. Element 10: wherein the preparing includes enabling use of a single completion queue entry (CQE) per set of aggregated responses for the one or more storage access requests or enabling use of one CQE per request of the one or more storage access requests. Element 11 wherein the preparing includes enabling use of a single completion queue entry (CQE) per set of aggregated responses for the one or more storage access requests and setting-up a counting semaphore for use in conjunction with the single CQE. Element 12: wherein the operations further include using a completion queue entry (CQE) for error notifications. Element 13: wherein the CQE is always updated. Element 14: wherein the CQE is relied upon to indicate completion of the one more storage access requests. Element 15: wherein the CQE is only relied upon to indicate an error. Element 16: wherein the CQE is not always updated with each of the completion notifications. Element 17: wherein the CQE is only used when there is an error with completion of the one or storage access requests. Element 18: wherein the operations further include using one or more semaphores for error notifications. Element 19: wherein the semaphore generates an error notification by counting down past zero. Element 20: wherein an initial value for the countdown is included in an index of the one or more storage access requests. Element 21: wherein a negative value for the countdown is defined that indicates an error to be polled. Element 22: wherein a negative value for the countdown is defined that indicates an error in an aggregated set of the one or more storage access requests. Element 23: wherein a sample index from one or more requests in the aggregated set having an error is used with the semaphore or an index of a first entry in the set having an error. Element 24 wherein one or more status locations with an error code are noted and read when the semaphore indicates the error. Element 25: wherein using the one or more semaphores includes managing a table thereof. Element 26: wherein the managing includes deallocating and resetting a counting semaphore and marking it as available for use at the one or more requesting agents. Element 27: wherein a receiving entity at one of the one or more requesting agents is configured to perform the deallocating, the resetting, and the marking Element 28: wherein the managing includes associating one or more of the semaphores with status locations having error code. Element 29: wherein the one or more requesting agents is configured to send an indication to a source of a response source to perform an action related to cleaning up a state of a semaphore. Element 30: wherein logic of the augmented data controller is distributed across one or more devices that include a storage controller, the one or more requesting agents, at least one intervening device, and the one or more data sources. Element 31: wherein the at least one intervening device includes a SSD-specific agent or a server agent for multiple SSDs. Element 32: wherein the communication bus is a PCIe bus. Element 33 wherein the operations further include preparing for the aggregating of the one or more storage access requests or the one or more completion notifications. Element 34: wherein the operations further include using a completion queue entry (CQE) for error notifications. Element 35: wherein the operations further include using one or more semaphores for error notifications. Element 36: wherein the processing includes sending completion notifications. Element 37: wherein the processing includes sending the completion notifications. Element 38: wherein the processing includes sending error notifications. Element 39: wherein the aggregation instructions include using a tag with each requests of an aggregated set of the one or more storage access requests to indicate corresponding responses or the completion notifications to aggregate. Element 40: wherein the aggregation instructions include a number of the corresponding responses or the completion notifications in the aggregated set. Element 41: wherein the operations further include counting the requests of the aggregated set or counting remaining requests of the aggregated set. Element 42: wherein the number of requests in the aggregated set is inserted as a special command or integrated into one of the requests of the aggregated set. Element 43: wherein the aggregation instructions indicate to aggregate based on consecutive data locations or to aggregate based on completion flag locations carried in one of the one or more storage access requests. Element 44: wherein messages that are explicitly handled by a receiving agent at the one or more requesting agents is used for communicating the aggregation instructions. Element 45: wherein the messages include a direct memory access (DMA) or a remote (RDMA). Element 46: wherein a network element is configured to enable scattering of data in response to the one or more storage access requests into the one or more requesting agents. Element 47: wherein a requirement for a single, contiguous write is relaxed or relaxed with limits. Element 48: wherein the aggregation instructions use a special command to indicate beginning of a sequence of the one or more access requests to aggregate, wherein a location/address of the special command is remembered and the special command is updated with a pointer to a later special command when a next such special command is enqueued to the same IO queue, wherein all commands between the special command and the later special command are noted for aggregation Element 49: wherein processing of the one or more storage access requests that are between distinct pairs of the special commands can be handled concurrently. Element 50: wherein the aggregation instructions are directed to multiple aggregated sets of the one or more storage access requests and request an aggregated completion notification after the completion of all members of each of the aggregated sets. Element 51: wherein the multiple aggregated sets overlap and are processed concurrently. Element 52: wherein the multiple aggregated sets overlap and are processed using a unique mark. Element 53: wherein the unique mark is a tag, a notification location, or a semaphore. Element 54: wherein the completion guidance includes assigning different priorities to different ones of the multiple aggregated sets. Element 55: wherein the one or more data sources is a data storage device, at least one intervening device, or a combination thereof. Element 56: wherein more than one of the one or more data sources provides data for the one or more data requests. Element 57: wherein the operations further include managing one or more of the data sources. Element 58: wherein the managing includes managing memory-mapped input/output (MMIO) reads or writes that have side effects. Element 59: wherein the managing includes a set of commands for allocating, freeing, checking the availability, and cleanup of the one or more data sources. Element 60: wherein the operations further include sending at least one of the completion notifications using a direct memory access (DMA), a remote DMA (RDMA), polling to an updated completion queue entry, or polling to a semaphore. Element 61: wherein the operations can be applied to different types of computing elements or storage elements that are configured to send back data in response to the one or more storage access requests.

What is claimed is:

1. An augmented data controller configured to perform one or more operations associated with processing storage access requests from one or more requesting agents for one or more data sources, the operations comprising:
generating completion guidance associated with the one or more storage access requests, wherein the completion guidance includes aggregation instructions for aggregating the one or more storage access requests or for aggregating completion notifications of the one or more storage access requests.

2. The augmented data controller as recited in claim 1, wherein the aggregation instructions include using a tag with each request of an aggregated set of the one or more storage access requests to indicate corresponding responses or the completion notifications to aggregate.

3. The augmented data controller as recited in claim 2, wherein the aggregation instructions include a number of the corresponding responses or the completion notifications in the aggregated set.

4. The augmented data controller as recited in claim 3, wherein the operations further include counting requests of the aggregated set or counting remaining requests of the aggregated set.

5. The augmented data controller as recited in claim 3, wherein the number is inserted as a special command or integrated into one of the requests of the aggregated set.

6. The augmented data controller as recited in claim 1, wherein the aggregation instructions indicate to aggregate based on consecutive data locations or to aggregate based on completion flag locations carried in one of the one or more storage access requests.

7. The augmented data controller as recited in claim 6, wherein messages that are explicitly handled by a receiving agent at the one or more requesting agents is used for communicating the aggregation instructions.

8. The augmented data controller as recited in claim 7, wherein the messages include a direct memory access (DMA) or a remote (RDMA).

9. The augmented data controller as recited in claim 6, wherein a network element is configured to enable scattering of data in response to the one or more storage access requests into the one or more requesting agents.

10. The augmented data controller as recited in claim 9, wherein a requirement for a single, contiguous write is relaxed or relaxed with limits.

11. The augmented data controller as recited in claim 1, wherein the aggregation instructions use a special command to indicate beginning of a sequence of the one or more access requests to aggregate, wherein a location/address of the special command is remembered and the special command is updated with a pointer to a later special command when a next such special command is enqueued to a same IO queue, wherein all commands between the special command and the later special command are noted for aggregation.

12. The augmented data controller as recited in claim 11, wherein processing of the one or more storage access requests that are between distinct pairs of the special commands are handled concurrently.

13. The augmented data controller as recited in claim 1, wherein the aggregation instructions are directed to multiple aggregated sets of the one or more storage access requests and request an aggregated completion notification after completion of all members of each of the aggregated sets.

14. The augmented data controller as recited in claim 13, wherein the multiple aggregated sets overlap and are processed concurrently.

15. The augmented data controller as recited in claim 13, wherein the multiple aggregated sets overlap and are processed using a unique mark.

16. The augmented data controller as recited in claim 15, wherein the unique mark is a tag, a notification location, or a semaphore.

17. The augmented data controller as recited in claim 13, wherein the completion guidance includes assigning different priorities to different ones of the multiple aggregated sets.

18. The augmented data controller as recited in claim 1, wherein the one or more data sources is a data storage device, at least one intervening device, or a combination thereof.

19. The augmented data controller as recited in claim 1, wherein more than one of the one or more data sources provides data for the one or more storage access requests.

20. The augmented data controller as recited in claim 1, wherein the operations further include managing one or more of the data sources.

21. The augmented data controller as recited in claim 20, wherein the managing includes managing memory-mapped input/output (MMIO) reads or writes that have side effects.

22. The augmented data controller as recited in claim 20, wherein the managing includes a set of commands for allocating, freeing, checking of availability, and cleanup of the one or more data sources.

23. The augmented data controller as recited in claim 1, wherein the operations further include sending at least one of the completion notifications using a direct memory access (DMA), a remote DMA (RDMA), polling to an updated completion queue entry, or polling to a semaphore.

24. The augmented data controller as recited in claim 1, wherein the operations are applied to different types of computing elements or storage elements that are configured to send back data in response to the one or more storage access requests.

25. A storage processing interface, comprising:
a communication bus; and
an augmented data controller connected to the communication bus and configured to perform one or more operations associated with processing storage access requests from one or more requesting agents for one or more data sources, the operations including:
providing completion guidance associated with the one or more storage access requests, wherein the completion guidance includes aggregation instructions for aggregating the one or more storage access requests or for aggregating completion notifications of the one or more storage access requests.

26. The storage processing interface as recited in claim 25, wherein the aggregation instructions include using a tag with each request of an aggregated set of the one or more storage access requests to indicate corresponding responses or the completion notifications to aggregate.

27. The storage processing interface as recited in claim 25, wherein the aggregation instructions indicate to aggregate based on consecutive data locations or to aggregate based on completion flag locations carried in one of the one or more storage access requests.

28. The storage processing interface as recited in claim 25, wherein the aggregation instructions are directed to multiple aggregated sets of the one or more storage access requests and request an aggregated completion notification after completion of all members of each of the aggregated sets.

29. A data storage system, comprising:
data storage configured to store data; and
a storage processing interface having an augmented data controller configured to perform operations that include providing completion guidance associated with one or more storage access requests, wherein the completion guidance includes aggregation instructions for aggregating the one or more storage access requests or for aggregating completion notifications of the one or more storage access requests.
